(19) United States
(12) Patent Application Publication
(10) Pub. No.: US 2022/0166271 A1
(43) Pub. Date: May 26, 2022

(54) ELECTRIC MOTOR WITH INJECTION MOLDED ROTOR COMPRISING AN AXIAL SUPPORT FOR A BALL BEARING

(71) Applicant: NIDEC Motors & Actuators (Germany) GmbH, Bietigheim-Bissingen (DE)

(72) Inventors: Jürgen SCHMID, Brackenheim (DE); Thomas KÜBLER, Untergruppenbach (DE)

(21) Appl. No.: 17/534,697

(22) Filed: Nov. 24, 2021

(30) Foreign Application Priority Data
Nov. 26, 2020 (DE) 102020131410.8

(51) Int. Cl. H02K 1/276; H02K 1/28; H02K 1/04; H02K 15/12; H02K 15/03; H02K 7/08

(52) U.S. Cl. CPC H02K 1/276; H02K 1/28; H02K 7/085; H02K 15/12; H02K 15/03; H02K 1/04

(57) ABSTRACT

An electric motor includes a rotor, a rotor shaft on which a rotor core is seated, and magnets connected radially outwards to the rotor core which is mounted rotatably about an axis of rotation in a ball bearing. The ball bearing includes a bearing inner ring and a stator which surrounds the rotor on an outside. At least the rotor core is encapsulated and injection-molded to define the rotor. The projections define an axial support of the bearing inner ring and are injection-molded on an end surface of the rotor which is adjacent to the ball bearing.

### CROSS REFERENCE TO RELATED APPLICATION

The present application claims priority under 35 U.S.C. § 119 to German Application No. 10 2020 131 410.8, filed on Nov. 26, 2020, the entire contents of which are hereby incorporated herein by reference.

### 1. FIELD OF THE INVENTION

The present disclosure relates to an electric motor.

### 2. BACKGROUND

Electric motors, referred to as internal rotor motors, have a rotor that is connected to a rotor shaft and is rotatably mounted in a housing. The rotor carries permanent magnets. The permanent magnets are arranged around a rotor core and are located on its outer surface. The rotor defines the geometric axes and directions which will also be used herein. A central axis coincides with the axis of symmetry of the rotor and, in the electric motor, also represents the axis of rotation of the rotor. The direction of the axis of rotation is the axial direction of the arrangement. The radial direction is characterized by increasing distance from the central axis. Thus, the permanent magnets of the rotor are located outside in the radial direction. Tangential to the rotor is the circumferential direction, at which each direction vector is oriented perpendicular to a radius of the arrangement. According to the prior art, the electric motor further includes a stator arranged radially outside the rotor and annularly surrounding the rotor on the outside. The side of the rotor closest to the busbar assembly is described as the top of the rotor.

Two bearing systems are usually provided for fixing the rotor. Often these bearings are designed as ball bearings, with the electromagnetic assemblies located between the bearings. For motors with increased noise requirements, the bearings are preloaded with a spring element. This applies an axial force to the end shields accommodating the bearings.

Therefore, the axially acting forces must be introduced into the rotor shaft via bearing inner rings of the ball bearing. The force can be introduced by a frictional or form fit between the outside of the rotor shaft and the bearing inner ring. A design with force introduction via a form fit is often associated with additional costs, since a retaining ring or a retaining washer must also be fitted.

### SUMMARY

Example embodiments of the present disclosure provide electric motors each including a simple connection of a bearing inner ring to a rotor shaft which absorbs axial forces.

An electric motor according to an example embodiment of the present invention includes a rotor and a stator. The rotor includes a rotor shaft, on which a rotor core is seated, which is adjoined by magnets, in particular permanent magnets, in a radial direction outwards. The rotor shaft is mounted rotatably about an axis of rotation in a ball bearing including a bearing inner ring. The stator surrounds the rotor on an outside. At least the rotor core of the rotor is overmolded in an injection molding process to define the rotor.

On an end surface of the rotor adjacent to the ball bearing, projections are made by injection molding to define an axial support for the bearing inner ring.

Such an example embodiment is particularly cost-effective, since additional components, such as retaining rings, can be dispensed with.

Undersides of the projections are supported on an upper side of the rotor core or an upper side of a laminated core of the rotor. The projections are preferably spaced from a central bore in the radial direction to the axis of rotation, so that the rotor shaft is exposed in a region of the projections. In an example embodiment, the projections each include a projecting base body on which a pin is seated. In this case, the base body includes a larger cross-section than the pin. The bearing inner ring rests on the pins.

The ball bearing preferably is located at the upper side of rotor or the rotor core.

Preferably, the projections extend parallel or substantially parallel to the axis of rotation and are evenly or substantially evenly spaced in the circumferential direction.

In order to ensure reliable force absorption in the axial direction, the projections in the radial direction to the axis of rotation are located exclusively at a level of the bearing inner ring.

Preferably, at least three projections are provided.

It is advantageous if the ball bearing is spring preloaded.

In an example embodiment, the ball bearing supports the rotor shaft on a side away from the stator in the motor housing by a bearing shield.

A magnet holder may be provided to fix a position of the permanent magnets of the rotor in the injection molding process, which is integrally formed with the projections.

There are preferably three projections which preferably have a circular or substantially circular cross-section. It is advantageous if the projections, which are circular or substantially circular in cross-section, are in operative contact with the bearing inner ring at free ends thereof.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings. Similar or similarly acting components are designated in the figures with the same reference signs.

FIG. 1 is a perspective view of a rotor of an electric motor according to an example embodiment of the present disclosure.

FIG. 2 is a longitudinal section through the rotor of FIG. 1 with rotor shaft and ball bearing.

FIG. 3 is a three-dimensional view of the set shown in FIG. 2.

### DETAILED DESCRIPTION

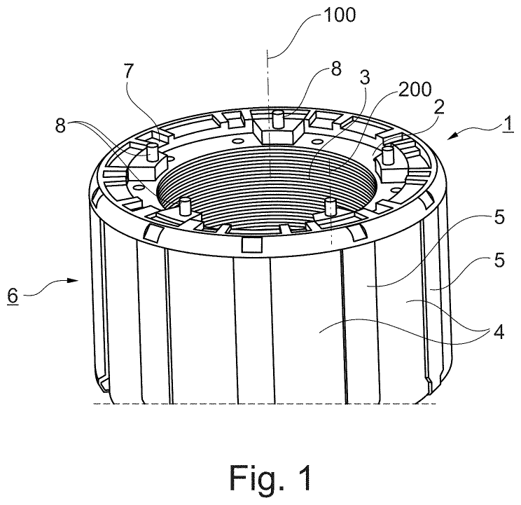

FIG. 1 shows a rotor 1 in a perspective view. The rotor 1 has a substantially rotationally symmetrical rotor core 2, which has a central bore 3 for receiving a rotor shaft not shown. The rotor core is formed as a laminated core. Uniformly spaced permanent magnets 4 are arranged around the rotor core 1. The permanent magnets 4 are held on the rotor core 2 by holding portions 5 of a magnet holder 6. The magnet holder 6 is formed by an injection molding method. On an upper surface 7 of the rotor, the magnet holder 6 has a number of projections 8 which are evenly spaced in the circumferential direction with respect to the rotational symmetry axis 100 of the rotor. The axis of rotational symmetry 100 of the rotor corresponds to the axis of rotation. The projections 8 protrude from the front side of the rotor at the upper side and extend with their longitudinal axes 200 parallel to the rotational symmetry axis 100 and are located at the level of the rotor core 2 in radial direction to the rotational symmetry axis 100. The projections 8 have a distance to the central bore 3 in radial direction to the rotational symmetry axis 100. The projections 8 each have a protruding base body on which a pin is seated. The base body has a larger cross-section than the pin. The projections 8 lie on an underside of the base body in contact with an upper side of the rotor core 2 or an upper side of the laminated core and are supported there. The protrusions 8 are formed when the rotor core is overmolded by injection molding. In the illustrated example embodiment example, a total of five projections 8 are formed.

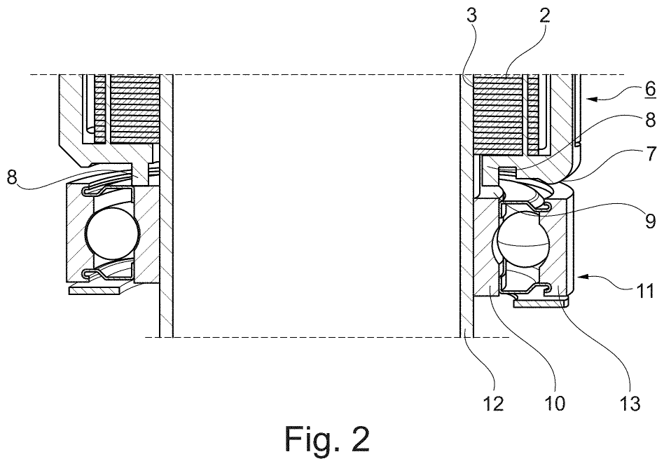

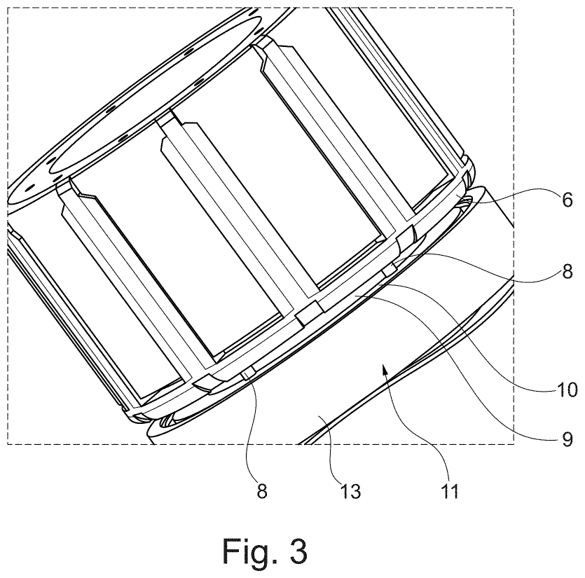

As shown in FIGS. 2 and 3, in the assembled state the projections 8 or the respective pin are in contact with an end surface 9 of a bearing inner ring 10 of a ball bearing 11. The bearing inner ring 10 is seated frictionally or positively on a rotor shaft 12 which passes through the central bore 3 of the rotor core 2. The bearing inner ring 10 thus bears against the upper surface of the magnet holder 6. The projections 8 are arranged and dimensioned in the radial direction so that they are in contact exclusively with the bearing inner ring 10 on a lower side, so that they can absorb an axial force introduction into the inner ring of the ball bearing. The bearing outer ring 13 is held stationary in a bearing shield, not shown, which is connected to a housing of the electric motor. The ball bearing 11 is a single row ball bearing. The ball bearing 11 is spring preloaded and lies on the upper side in contact with a spring element, in particular a spring washer or corrugated washer. The ball bearing is the bearing element close to the busbar unit.

By forming the protrusions 8 during the manufacture of the rotor by injection molding, no additional complex manufacturing steps are necessary.

In the example embodiment shown, the projections 8 are formed integrally with the magnet holder 6 of the rotor. However, it is also known to overmold the rotor around the permanent magnets, for example. Regardless of which component of the rotor is formed by injection molding, the projections can be produced in the same step.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electric motor, comprising:
a rotor including a rotor shaft on which a rotor core is seated, which is adjoined by magnets in a radial direction outwards, and which is mounted rotatably about an axis of rotation in a ball bearing including an inner bearing ring; and
a stator surrounding the rotor on an outside, at least the rotor core being overmolded to define the rotor; wherein
projections are defined on an end surface of the rotor adjacent to the ball bearing; and
the projections define an axial support of the bearing inner ring.

2. The electric motor according to claim 1, wherein the projections extend parallel or substantially parallel to the axis of rotation and are uniformly or substantially uniformly spaced in the circumferential direction.

3. The electric motor according to claim 1, wherein the projections are located in a radial direction away from the axis of rotation at an axial level of the bearing inner ring.

4. The electric motor according to claim 1, a number of projections is three.

5. The electric motor according to claim 1, wherein the ball bearing is spring preloaded.

6. The electric motor according to claim 1, wherein the ball bearing supports the rotor shaft in the motor housing on a side away from the stator through a bearing plate.

7. The electric motor according to claim 1, wherein a magnet holder to fix position of the magnets of the rotor is injection molded and integral with the projections in a single monolithic structure.

8. The electric motor according to claim 1, wherein the projections have a circular or substantially circular cross-section.

9. The electric motor according to claim 8, wherein the projections are in operative contact with the bearing inner ring at free ends thereof.
